(19) United States
(12) Patent Application Publication
(10) Pub. No.: US 2009/0133573 A1
(43) Pub. Date: May 28, 2009

(54) METHOD FOR IDENTIFICATION OF THE DRIVE TYPE OF AN ACTUATING DRIVE

(75) Inventors: Thomas Kleegrewe, Minden (DE); Stefan Engelke, Haste (DE); Andreas Stelter, Minden (DE); Wolfgang Scholz, Minden (DE); Urs E. Meier, Wurenlingen (CH); Detlef Pape, Nussbaumen (CH)

Correspondence Address: BUCHANAN, INGERSOLL & ROONEY PC, POST OFFICE BOX 1404, ALEXANDRIA, VA, 22313-1404, US

(73) Assignee: ABB AG, Mannheim (DE)

(21) Appl. No.: 12/195,689

(22) Filed: Aug. 21, 2008

(30) Foreign Application Priority Data
Aug. 22, 2007 (DE) 10 2007 039 716.1

(51) Int. Cl. F15B 19/00; F15B 13/00; F15B 15/02

(52) U.S. Cl. 91/361; 91/358 R; 91/368

(57) ABSTRACT

The disclosure relates to a method for identification of the drive type of an actuating drive, e.g., a pneumatic actuating drive, having a position regulator in order to control an actuating member in a process installation. The actuating drive is connected by means of an attachment to the position regulator, with the position regulator having control electronics which receive one or more input signals with the aid of a microcontroller and emit actuating signals in order to ventilate or vent the chambers of a single-acting or double-acting pneumatic drive. The position feedback sensor system is equipped with a rotational measurement system. The actuating range of the actuating drive is passed through completely while setting it up. The angle positions signaled back are recorded. The drive type is determined from the range between the limit angle positions at the actuating range limits of the actuating drive. The knowledge that the angle ranges covered by linear-movement drives and pivoting drives differ significantly can be made use of.

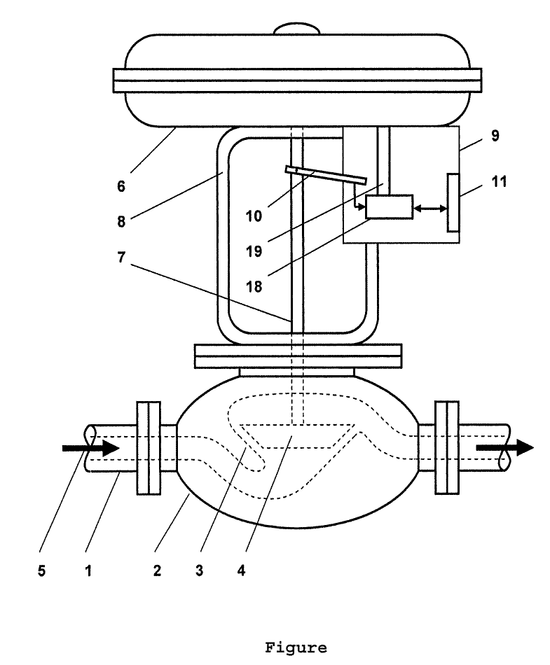

### RELATED APPLICATION

This application claims priority under 35 U.S.C. §119 to German Patent Application No. 10 2007 039 716.1 filed in Germany on Aug. 22, 2007, the entire content of which is hereby incorporated by reference in its entirety.

### TECHNICAL FIELD

The disclosure relates to a method for identification of the drive type of an actuating drive, e.g., a pneumatic actuating drive, having a position regulator for control of an actuating member in a process installation.

### BACKGROUND INFORMATION

The expression “digital position regulator” used in this disclosure refers to a mechatronic system which controls the auxiliary energy of a pneumatic actuating drive in accordance with one or more input signals, in order to move the actuating member to a specific position. In order to operate, the digital pneumatic position regulator requires pressurized gas as auxiliary energy, and electrical energy.

The digital pneumatic position regulator which forms this generic type has at least the core components described in more detail in the following text. The chambers of a single-acting or double-acting pneumatic drive are ventilated or vented deliberately by a pneumatic system, as a function of one or more input signals. The movements and positions of the actuating member are represented as one or more signals with the aid of a position feedback sensor system. Furthermore, control electronics are provided, that have a microcontroller, and receive one or more input signals. The firmware in the control electronics processes the input signals and the signals from the position feedback sensor system to form output signals which are used as input signals for the pneumatic system.

The firmware for the digital position regulator implements a function which analyzes the dynamic characteristics of the connected actuating drive. While being set up, the control range of the actuating member is moved through once during the initialization process, and the initial value and final value of the actuating range are recorded.

Actuating drives are subdivided into pivoting drives and linear-movement drives. In the case of a linear-movement drive, the linear movement of the output drive of the actuating drive is transmitted directly to a linearly operated actuating member. In contrast, in the case of a pivoting drive, the linear movement of the output drive of the actuating drive is converted to a rotary movement, by suitable means.

The actuating drive and the digital position regulator are connected by means of an attachment. The attachment comprises components which transmit the movement and position of the actuating drive to the position feedback sensor system for the position regulator.

The known measurement systems in the position feedback sensor system measure either linearly or on a rotating basis, as is known from DE 42 39 635 A1. If the operation direction of the actuating drive differs from the operating direction of the measurement system, the measurement must be linearized in order to ensure a sufficiently accurate positioning response. However, this is essentially dependent on knowledge of the existing drive type, pivoting drive or linear-movement drive. For this purpose, the operator must carry out a manual adjustment process for the known position regulator during the setting-up process, and this is susceptible to errors.

### SUMMARY

The disclosure relates to a method, arrangement and system for automatic identification of the drive type in order to use the same digital position regulator, without any manual action.

A method is disclosed for identification of the drive type of an actuating drive having a position regulator for controlling an actuating member, with the position regulator having control electronics which receive one or more input signals with the aid of a microcontroller and emit actuating signals in order to ventilate or vent the chambers of a single-acting or double-acting pneumatic drive, and with the position of the actuating member being signaled by a rotational measurement system to the position regulator, wherein the actuating range of the actuating drive is passed through completely while setting it up, in that the angle positions signaled back from the rotational measurement system are recorded, and in that the drive type is determined from the range between the limit angle positions at the actuating range limits of the actuating drive

In another aspect, an arrangement is disclosed for identification of an actuating drive type. Such an arrangement comprises an actuating drive based on a single-acting or double-acting pneumatic drive having chambers; a position regulator for controlling an actuating member; and control electronics associated with the position regulator which receive one or more input signals with the aid of a microcontroller and emit actuating signals in order to ventilate or vent the chambers of the single-acting or double-acting pneumatic drive, the position of the actuating member being signaled to the position regulator. The actuating range of the actuating drive is passed through completely while setting it up, the signaled angle positions are recorded, and the drive type is determined from the range between the limit angle positions at the actuating range limits of the actuating drive.

In another aspect, a system is disclosed for identification of a drive type relating to an actuating member in a process installation. Such a system comprises a actuating drive having chambers; a position regulator to control the actuating member in a process installation, the actuating drive being connected to the position regulator using an attachment; and control electronics associated with the position regulator which receive one or more input signals with the aid of a microcontroller and emit actuating signals in order to ventilate or vent the chambers of the actuating drive. The drive type is determined based on actuating range limits of the actuating drive.

### BRIEF DESCRIPTION OF THE DRAWING

The single FIGURE shows an exemplary pipeline of a process installation with a process valve as an exemplary actuating member.

### DETAILED DESCRIPTION

The disclosure is based on the known actuating drive which is connected by means of an attachment to a position regulator, with the position regulator having control electronics which receive one or more input signals with the aid of a microcontroller and in which actuating signals in order to ventilate or vent the chambers of a single-acting or double-acting pneumatic drive. The position feedback sensor system is equipped with a rotational measurement system.

According to the disclosure, the actuating range of the actuating drive is passed through completely while setting it up. The fed-back angle positions are recorded during this process. The drive type is determined from the range between the limit angle positions at the actuating range limits of the actuating drive. In this case, the disclosure makes use of the fact that the angle ranges covered by linear-movement drives and pivoting drives differ significantly.

The disclosure requires no additional hardware in the present exemplary embodiment, in comparison to the known actuating drive.

The disclosure will be explained in more detail in the following text with reference to one exemplary embodiment. The single FIGURE shows a pipeline 1, indicated in fragmental form, of a process installation, which is not illustrated in any more detail, with a process valve 2 as the actuating member. In its interior, the process valve 2 has a closure body 4, which interacts with a valve seat 3, in order to control the amount of process medium 5 passing through. The closure body 4 is operated linearly by a pneumatic actuating drive 6, via a push rod 7. The actuating drive 6 is connected to the process valve 2 via a yoke 8. A digital position regulator 9 is fitted to the yoke 8. The linear movement of the push rod 7 is signaled to the position regulator 9 via a position sensor 10. The detected linear movement is compared with the nominal value, as supplied via a communication interface 11, in control electronics 18, and the actuating drive 6 is operated as a function of the determined control error. The control electronics 18 for the position regulator 9 use an I/P converter to convert an electrical control error to an adequate control pressure. The I/P converter for the position regulator 9 is connected to the actuating drive 6 via a pressure-medium supply 19.

The position regulator 9 has a potentiometer which is operatively connected to the position sensor 10. The linear movement of the push rod 7 is converted to a rotary movement via the position sensor 10. In the linear-movement drive illustrated in the FIGURE, the angle range covered on the potentiometer is limited, for linearity reasons. Angle ranges of up to 60° are usual in this case.

In contrast, in the case of pivoting drives, angle ranges of about 90° are covered in order to move a flap in a pipeline between minimum resistance in the “open” state along the flow direction in the pipeline and maximum resistance in the “closed” state transversely with respect to the is flow direction in the pipeline.

The actuating range of the actuating drive 6 is moved through completely while setting it up. During this process, the fed-back angle positions are recorded. The drive type is determined from the range between the limit angle positions at the actuating range limits of the actuating drive 6.

Actuating drives with measured angle ranges of more than 70° are identified as pivoting drives, and all the others as linear-movement drives, based on the above significant differences between the angle ranges covered by linear-movement drives and pivoting drives.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

List of reference symbols

| | |
|---|---|
| 1 | Pipeline |
| 2 | Process valve |
| 3 | Valve seat |
| 4 | Closure body |
| 5 | Process medium |
| 6 | Actuating drive |
| 7 | Valve rod |
| 8 | Yoke |
| 9 | Position regulator |
| 10 | Position sensor |
| 11 | Communication interface |
| 18 | Control electronics |
| 19 | Pressure-medium supply |

What is claimed is:

1. A method for identification of the drive type of an actuating drive having a position regulator for controlling an actuating member, with the position regulator having control electronics which receive one or more input signals with the aid of a microcontroller and emit actuating signals in order to ventilate or vent the chambers of a single-acting or double-acting pneumatic drive, and with the position of the actuating member being signaled by a rotational measurement system to the position regulator,
wherein
the actuating range of the actuating drive is passed through completely while setting it up,
the angle positions signaled back from the rotational measurement system are recorded, and
the drive type is determined from the range between the limit angle positions at the actuating range limits of the actuating drive.

2. The method as claimed in claim 1,
wherein
actuating drives (with measured angle ranges of more than 70° are identified as pivoting drives.

3. An arrangement for identification of an actuating drive type, comprising:
an actuating drive based on a single-acting or double-acting pneumatic drive having chambers;
a position regulator for controlling an actuating member; and
control electronics associated with the position regulator which receive one or more input signals with the aid of a microcontroller and emit actuating signals in order to ventilate or vent the chambers of the single-acting or double-acting pneumatic drive, the position of the actuating member being signaled to the position regulator, wherein
the actuating range of the actuating drive is passed through completely while setting it up,
the signaled angle positions are recorded, and
the drive type is determined based on a range between the limit angle positions at the actuating range limits of the actuating drive.

4. The arrangement as claimed in claim 3, wherein the position of the actuating member is signaled by a rotational measurement system to the position regulator.

5. A system for identification of a drive type relating to an actuating member in a process installation, the system comprising:
an actuating drive having chambers;
a position regulator to control the actuating member in a process installation, the actuating drive being connected to the position regulator using an attachment; and
control electronics associated with the position regulator which receive one or more input signals with the aid of a microcontroller and emit actuating signals in order to ventilate or vent the chambers of the actuating drive, wherein the drive type is determined based on actuating range limits of the actuating drive.

6. The system as claimed in claim 5, wherein the actuating drive is either a single-acting or double-acting pneumatic drive.

7. The system as claimed in claim 5, comprising a position feedback sensor system equipped with a rotational measurement system.

8. The system as claimed in claim 5, wherein the drive type is determined based on a range between limit angle positions associated with actuating range limits of the actuating drive, accounting for differences in ranges associated with linear-movement drives and pivoting drives.
